(19) United States
(12) Patent Application Publication
(10) Pub. No.: US 2009/0110835 A1
(43) Pub. Date: Apr. 30, 2009

(54) ADDITIVES FOR IMPROVED ADHESION TO OILY SUBSTRATES

(76) Inventors: MARK W. PRESSLEY, Cary, NC (US); Kirk J. Abbey, Garner, NC (US); Sandra L. Case, Holly Springs, NC (US)

Correspondence Address: LORD CORPORATION;PATENT & LEGAL SERVICES, 111 LORD DRIVE, P.O. Box 8012, CARY, NC, 27512-8012, US

(21) Appl. No.: 12/261,726

(22) Filed: Oct. 30, 2008

Related U.S. Application Data
(60) Provisional application No. 60/983,947, filed on Oct. 31, 2007.

(51) Int. Cl. B05D 3/00; C08K 5/01

(52) U.S. Cl. 427/331; 524/474; 524/481

(57) ABSTRACT

An adhesive composition is provided which is capable of bonding to metallic surfaces which are contaminated with oil or oily residue. An adhesion improving additive is added to the base adhesive/coating composition which enables the adhesive to achieve better bonding to oily substrates. Addition of the adhesion improving additive improves the adhesion of adhesives, sealants, and coatings to the oily substrates used in the automotive and industrial markets. The an adhesion improving additive is an aliphatic molecule of at least 8 carbon atoms or having an aliphatic end group or side chain of least 6 carbon atoms, and wherein the adhesion improving additive comprises a boiling point of at least 30° C.

### CROSS-REFERENCE TO RELATED APPLICATIONS

The present application claims priority under 35 U.S.C. §119(e) from U.S. Provisional Patent Application Ser. No. 60/983,947 filed Oct. 31, 2007, entitled “ADDITIVES FOR IMPROVED ADHESION TO OILY SUBSTRATES”, the disclosure of which is incorporated herein by reference.

### FIELD OF THE INVENTION

The invention relates to curable adhesives or coatings employing an adhesion improving additive which allows the curable composition to adhere to oily substrates without the need for mechanical wiping or surface treatments prior to bonding.

### BACKGROUND OF THE INVENTION

Curable structural adhesive compositions are commonly used to bond metal parts. Such bonding of metal parts is widely employed in the automobile industry where adhesive bonding is replacing welding to provide better structural connectivity between the parts and faster assembly time. However, parts often remain at least partially coated with oil employed in the part manufacturing process or used to lubricate machinery, and oily substrates are notoriously difficult to bond.

Presently, this problem is overcome by manually wiping the oil from the substrate, or by employing a solvent-based cleaner to remove oil from the substrate surface prior to application of the adhesives. These cleaners are typically low boiling point organic solvents in which the part is dipped, or the cleaner is wiped on the part with a cloth. The oil is removed and any excess cleaner quickly evaporates leaving a cleaned metal surface. It is further important that all of the cleaner be removed prior to bonding so as to avoid blistering of the adhesive due to residual cleaner flashing off during the cure cycle. For this reason, it is critical to employ a cleaner with a boiling point well below room temperature.

Additionally, adhesion promoters are often added to the adhesive composition in an attempt to improve the adhesive performance which was lost due to the oil coated substrate. Unfortunately, most adhesion promoters suffer detrimental adhesion performance on oil coated substrates unless the oil is removed to allow the adhesion promoter to have access to the substrate surface.

It would therefore be commercially desirable to provide a structural adhesive which is capable of bonding to oily substrates without the need for mechanical wiping or chemical surface treatments.

It is to this perceived need that the present invention is directed.

### SUMMARY OF THE INVENTION

In a first aspect of the present invention, an adhesive composition is provided which is capable of bonding to metallic surfaces which are contaminated with oil or oily residue.

In the present invention, an adhesion improving additive is added to the base adhesive/coating composition which enables the adhesive to achieve better bonding to oily substrates. Addition of the adhesion improving additive improves the adhesion of adhesives, sealants, and coatings to the oily substrates used in the automotive and industrial markets.

In one embodiment of the present invention, a curable adhesive composition is provided comprising an adhesion improving additive comprising an aliphatic molecule of at least 8 carbon atoms or having an aliphatic end group or side chain of least 6 carbon atoms, and wherein the adhesion improving additive comprises a boiling point of at least 30° C.

In another embodiment of the present invention, the adhesion improving additive comprises a higher alkane, in another embodiment a C₁₀-C₂₀ alkane, and in another embodiment a C₁₄-C₁₈ alkane, and in another embodiment the adhesion improving additive comprises hexadecane. In a further embodiment of the present invention, the adhesion improving additive comprises a boiling point of at least 100° C. and in another embodiment at least 180° C.

In a still further embodiment of the present invention, the adhesion improving additive comprises at least one of branched alkanes, cyclic alkanes, acyclic alkanes, mineral oils, alpha olefins, and Fisher-Tropsch oils. In another embodiment of the present invention, the adhesion improving additive comprises a functional moiety enabling the additive to react into the adhesive composition while the adhesive composition curing.

In one embodiment of the present invention, the adhesion improving additive is present from about 0.1 to about 15 weight percent, in another embodiment about 1.0 to about 10 weight percent, and in another embodiment about 1.0 to about 6.0 weight percent. In a still further embodiment of the present invention, the curable composition comprises an epoxy component.

In yet another embodiment of the present invention, the curable composition further comprises a radical-polymerizable component; and in a further embodiment the radical polymerizable component comprises an alkacrylate.

In one embodiment of the present invention, the curable composition comprises an epoxy/acrylate hybrid adhesive. In another embodiment of the present invention, the curable composition comprises a two-part structural adhesive comprising in part A: about 10-90% by weight of at least one free radical-polymerizable monomer; (b) about 0-20% by weight of an adhesion promoter; (c) a toughener; (d) a reducing agent; and in part B: an epoxy resin, and an oxidizing agent.

In a further aspect of the present invention, a method of bonding to an oily substrate is provided comprising:

a) providing a substrate having an oily residue on a surface portion thereof;

b) providing an adhesive composition comprising an adhesion improving additive having a boiling point of at least 30° C.;

c) dispensing the adhesive composition onto the oily substrate surface;

d) allowing the adhesion improving additive to remove at least some of the oily residue from the substrate surface; and,

e) curing the adhesive composition such that it forms a stronger bond to the substrate than the same adhesive composition would without the adhesion improving additive.

In one embodiment of the present invention, the adhesion improving additive comprises an aliphatic molecule of at least 8 carbon atoms or having an aliphatic end group or side chain of at least 6 carbon atoms. In another embodiment the adhesive composition is cured at a predetermined temperature above 30° C., and the adhesion improving additive comprises a boiling point that is higher than the predetermined temperature. In a further embodiment of the present invention the substrate comprises a metal substrate.

### DETAILED DESCRIPTION OF THE INVENTION

In a first aspect of the present invention, an adhesive is provided comprising a curable component and an adhesion improving additive.

Proper selection of the adhesion improving additive has demonstrated the ability to improve adhesion to oily substrates without the use of the conventional techniques for removing the oil prior to bonding. While not wishing to be bound by the theory, the mechanism for enhanced adhesion appears to be related to the fact that when the additive is similar to the oil in its molecular structure, a “like dissolves like” approach solvates the oils/lubricants removing them from the surface and allowing better contact between the adhesive and the substrate surface.

The adhesives employed in embodiments of the present invention comprise those adhesive formulations employed to bond substrates which may be contaminated with oil. As these tend to be automotive and industrial adhesives used in the automotive, aerospace and industrial markets, the oil contaminants are often hydrocarbon based oils such as natural and synthetic lubricating oils, machine oils, cutting/stamping oils, blanking washes, pre-lubricants, spot-spray lubricants, protectant oils, and the like.

Any suitable adhesive material may be used in the present invention, provided that it is able to bond to the components to be bonded together. Common structural adhesives include acrylics, epoxies, and urethanes or combinations thereof. However, acrylics and epoxies are the most common structural adhesives providing the necessary bond and performance characteristics for these applications.

In one embodiment of the present invention, the adhesive comprises a two part structural adhesive herein the A side comprises a) 10-90, preferably 20-70, weight percent of an olefinic monomer selected from the group consisting of (meth)acrylic acid; esters, amides or nitrites of (meth)acrylic acid; maleate esters; fumerate esters; vinyl esters; conjugated dienes; itaconic acid; styrenic compounds; and vinylidene halides; (b) 10-80, preferably 20-50, weight percent of the primary toughener; (c) 0-15, preferably 1-10, weight percent of the auxiliary toughener; (d) 0-20, preferably 2-10, weight percent of a phosphorus adhesion promoter compound having one or more olefinic groups, (e) 0.05-10, preferably 0.1-6, weight percent of at least one reducing agent which is interactive with an oxidizing agent to produce free radicals which are capable of initiating and propagating free radical polymerization reactions; and in the B-Side or second package a bonding activator containing an oxidizing agent of a room temperature-active redox couple catalyst system, the oxidizing agent being reactive at room temperature with the reducing agent, and 3-6 % wt. on total weight of A and B sides, of an epoxy resin.

In another embodiment of the present invention, the adhesive comprises a structural adhesive based on a two-part composition such as those described in commonly-assigned U.S. Patent Application Publication No. 2006/0264573, entitled “Ambient Curable Protective Sealant”, herein incorporated by reference in full. The adhesives described therein are directed toward composition comprising a radical polymerizable component, an oxidizing agent and a reducing agent, and optionally an epoxy component, polar wax, and/or rheology modifier. The radical-polymerizable component contains 25 to 45 weight percent of alkacrylate monomer and unsaturated phosphorous monomer and 55 to 75 weight percent of an ethylenic unsaturated liquid elastomer polymer having a number average MW of from 3,000 to 9,500 and a backbone T_{g} less than −30° C. The elastomer polymer makes up 32 to 55 weight percent of the sealant and epoxy component makes up 2 to 15 weight percent.

In further embodiment of the present invention, the adhesive comprises an epoxy-based adhesive resin such as a liquid diglycidyl ether of Bisphenol-A. The epoxy adhesive may optionally comprise flexibilizers such as rubbers and urethane elastomers. The epoxy resin component can be filled with known fillers such as talc, alumina, glass beads, kaolin, etc. to such an extent that they exhibit gravity flow properties (viscosity about 200,000 cps or lower). Epoxies are typically cured with heat or an amine or amide curing agents.

The adhesion improving additive comprises a adhesion improving additive which allows the adhesive to penetrate an oily coating on a substrate to better adhere to the underlying substrate. Further, the adhesion improving additive must not negatively impact the other constituents present in the adhesive formulation.

Proper selection of the additive is critical to the success of the adhesive. The additive must be similar in structure to the oil/lubricant, yet be compatible with the adhesive formulation. For a curable adhesive, the additive must not initiate the cure prematurely, for example if a tertiary amine curative is employed, the solvent must not be acidic so as not to set off the cure reaction prior to application to a substrate. Additionally, the additive must not interfere with the cure mechanism such as by quenching free radicals.

Therefore, in one embodiment of the present invention, the adhesion improving additive comprises an aliphatic molecule of at least 8 carbon atoms or has an aliphatic end group or side chain of at least 6 carbon atoms, and a boiling point of at least 30° C. The aliphatic chain/group allows the adhesion improving additive to interact with the oily residue on the surface of a substrate to provide the adhesive better access to the substrate surface.

In a more preferred embodiment the boiling point of the adhesion improving additive is greater than 100° C., and most preferably greater than 180° C. In another embodiment of the present invention, wherein the adhesive formulation is applied and cured at an elevated temperature, the boiling point of the adhesion improving additive is greater than elevated cure temperature to prevent the additive from vaporizing and interfering with the adhesive cure.

In a most preferred embodiment of the present invention, the adhesion improving additive comprises an aliphatic hydrocarbon having at least 8 carbon atoms in the primary chain. In a more preferred embodiment of the present invention, the adhesion improving additive comprises a higher alkane, preferably a C₁₀ to C₂₀ alkane. In a even more preferred embodiment of the present invention, the adhesion improving additive comprises a higher alkane, preferably a C₁₄ to C₁₈ alkane. In a most preferred embodiment of the present invention, the adhesion improving additive comprises hexadecane. The alkane may comprise, for example, branched alkanes, cyclic alkanes, acyclic alkanes, mineral oils, alpha olefins, Fisher-Tropsch oils and mixtures thereof.

In an additional embodiment of the present invention, the adhesion improving additive further comprises a functionalizing moiety allowing it to react into the network of the curable composition.

In one embodiment of the present invention, the adhesion improving additive is present from about 0.10 weight percent to about 15 weight percent based on the total weight of the composition, or when employed in a two part adhesive, the total weight of the A-side. In another embodiment of the present invention, the adhesion improving additive is present from about 1.0 to about 10 weight percent based on the total weight of the composition, or when employed in a two part adhesive, the total weight of the A-side. In a most preferred embodiment of the present invention, the adhesion improving additive is present from about 1.0 to about 6.0 weight percent based on the total weight of the composition, or when employed in a two part adhesive, the total weight of the A-side.

### EXAMPLES

Curable compositions of the embodiments of the present invention including tile adhesion improving additive have shown the ability to improve adhesion even through wax containing oils such as Multidraw® PL 61, a metal forming lubricant available from Zeller+Gmelin (Germany), and have the potential of improving adhesion through waxy lubricants such as Multidraw Drylube E 1 (also available from Zeller+Gmelin). The Drylube-type lubricants have proved to be problematic for most adhesives to bond through.

Experiments were performed by adding various levels of hexadecane to a commercially available epoxy/acrylate structural adhesive. The adhesive was applied to hot-dipped galvanized steel panels coated with Multidraw PL 61 at 3 g/m² in a bead configuration (approximately 10 mm wide and 3 mm thick).

| | Composition A | Composition B | Prior Art |
|---|---|---|---|
| Ingredient | wt % | wt % | wt % |
| Epoxy/acrylate structural | 98.0 | 95.0 | 100 |
| adhesive | | | |
| Hexadecane | 2.00 | 5.00 | 0.00 |
| TOTAL | 100.00 | 100.00 | 100.00 |

After the material had cured at room temperature for over 4 hours, the panels were post baked at 180° C. for 30 minutes then allowed to return to room temperature. Adhesion is then verified by using a putty knife to cut the bead off of the panel. Comparison of failure modes indicates an increase in cohesive failure (preferred mode) from 0-10% in formulations without the additive to 100% in formulations containing the additive.

The rating system is based on a rating of 1-6, where a rating of 1 corresponds to excellent adhesion (100% cohesive failure) and a rating of 6 corresponds to poor adhesion (100% a adhesive failure).

| Material | Adhesion Rating |
|---|---|
| Prior Art | 3 (40% adhesive failure) |
| Composition A | 1 |
| Composition B | 1 |

Although the present invention has been described with reference to particular embodiments, it should be recognized that these embodiments are merely illustrative of the principles of the present invention. Those of ordinary skill in the art will appreciate that the compositions, apparatus and methods of the present invention may be constructed and implemented in other ways and embodiments. Accordingly, the description herein should not be read as limiting the present invention, as other embodiments also fall within the scope of the present invention as defined by the appended claims.

What is claimed is:

1. A curable adhesive composition comprising an adhesion improving additive comprising an aliphatic molecule of at least 8 carbon atoms or having an aliphatic end group or side chain of least 6 carbon atoms, and wherein the adhesion improving additive comprises a boiling point of at least 30° C.

2. The composition of claim 1, wherein the adhesion improving additive comprises a higher alkane.

3. The composition of claim 1, wherein the adhesion improving additive comprises a C₁₀-C₂₀ alkane.

4. The composition of claim 3, wherein the adhesion improving additive comprises a C₁₄-C₁₈ alkane.

5. The composition of claim 1, wherein the adhesion improving additive comprises hexadecane.

6. The composition of claim 1, wherein the adhesion improving additive comprises a boiling point of at least 100° C.

7. The composition of claim 1, wherein the adhesion improving additive comprises a boiling point of at least 180° C.

8. The composition of claim 1, wherein the adhesion improving additive comprises at least one of branched alkanes, cyclic alkanes, acyclic alkanes, mineral oils, alpha olefins, and Fisher-Tropsch oils.

9. The composition of claim 1, wherein the adhesion improving additive comprises a functional moiety enabling the additive to react into the adhesive composition while the adhesive composition curing.

10. The composition of claim 1, wherein the adhesion improving additive is present from about 0.1 to about 15 weight percent.

11. The composition of claim 1, wherein the adhesion improving additive is present from about 1.0 to about 10 weight percent.

12. The composition of claim 1, wherein the adhesion improving additive is present from about 1.0 to about 6.0 weight percent.

13. The composition of claim 1, wherein the curable composition comprises an epoxy component.

14. The composition of claim 1, wherein the curable composition further comprises a radical-polymerizable component.

15. The composition of claim 14, wherein the radical polymerizable component comprises an alkacrylate.

16. The composition of claim 1, wherein the curable composition comprises an epoxy/acrylate hybrid adhesive.

17. The composition of claim 1, wherein the curable composition comprises a two-part structural adhesive comprising in part A: about 10-90% by weight of at least one free radical-polymerizable monomer; (b) about 0-20% by weight of an adhesion promoter; (c) a toughener; (d) a reducing agent; and in part B: an epoxy resin, and an oxidizing agent.

18. A method of bonding to an oily substrate comprising:
a) providing a substrate having an oily residue on a surface portion thereof,
b) providing an adhesive composition comprising an adhesion improving additive having a boiling point of at least 30° C.;
c) dispensing the adhesive composition onto the oily substrate surface;
d) allowing the adhesion improving additive to remove at least some of the oily residue from the substrate surface; and,
e) curing the adhesive composition such that it forms a stronger bond to the substrate than the same adhesive composition would without the adhesion improving additive.

19. The method of claim 18, wherein the adhesion improving additive comprises an aliphatic molecule of at least 8 carbon atoms or having an aliphatic end group or side chain of at least 6 carbon atoms.

20. The method of claim 18, wherein the adhesive composition is cured at a predetermined temperature above 30° C., and the adhesion improving additive comprises a boiling point that is higher than the predetermined temperature.

21. The method of claim 18, wherein the adhesion improving additive comprises a higher alkane.

22. The method of claim 18, wherein the adhesion improving additive comprises a C₁₀-C₂₀ alkane.

23. The method of claim 18, wherein the adhesion improving additive comprises a C₁₄-C₁₈ alkane.

24. The method of claim 18, wherein the adhesion improving additive comprises hexadecane.

25. The method of claim 18, wherein the adhesion improving additive comprises a boiling point of at least 100° C.

26. The method of claim 18, wherein the adhesion improving additive comprises a boiling point of at least 180° C.

27. The method of claim 18, wherein the adhesion improving additive comprises at least one of branched alkanes, cyclic alkanes, acyclic alkanes, mineral oils, alpha olefins, and Fisher-Tropsch oils.

28. The method of claim 18, wherein the adhesion improving additive comprises a functional moiety enabling the additive to react into the adhesive composition while the adhesive composition curing.

29. The method of claim 18, wherein the adhesion improving additive is present from about 0.1 to about 15 weight percent.

30. The method of claim 18, wherein the adhesion improving additive is present from about 1.0 to about 10 weight percent.

31. The method of claim 18, wherein the adhesion improving additive is present from about 1.0 to about 6.0 weight percent.

32. The method of claim 18, wherein the curable composition comprises an epoxy component.

33. The method of claim 18, wherein the curable composition further comprises a radical-polymerizable component.

34. The method of claim 33, wherein the radical polymerizable component comprises an alkacrylate.

35. The method of claim 18, wherein the curable composition comprises an epoxy/acrylate hybrid adhesive.

36. The method of claim 18, wherein the curable composition comprises a two-part structural adhesive comprising in part A: about 10-90% by weight of at least one free radical-polymerizable monomer; (b) about 0-20% by weight of an adhesion promoter; (c) a toughener; (d) a reducing agent; and in part B: an epoxy resin, and an oxidizing agent.

37. The method of claim 18, wherein the substrate comprises a metal substrate.
